(19) United States
(12) Patent Application Publication
(10) Pub. No.: US 2009/0115613 A1
(43) Pub. Date: May 7, 2009

(54) ASSOCIATION OF RACK MOUNTED EQUIPMENT WITH RACK POSITION

(75) Inventors: William J. PIAZZA, Holly Springs, NC (US); Richard E. HARPER, Chapel Hill, NC (US)

Correspondence Address: IBM (RPS-BLF);c/o BIGGERS & OHANIAN, LLP, P.O. BOX 1469, AUSTIN, TX, 78767-1469, US

(73) Assignee: INTERNATIONAL BUSINESS MACHINES CORPORATION, Armonk, NY (US)

(21) Appl. No.: 11/934,034

(22) Filed: Nov. 1, 2007

(51) Int. Cl. G08B 13/14

(52) U.S. Cl. 340/572.8

(57) ABSTRACT

System, method, and computer program for associating a piece of equipment mounted at a position on a rack with the rack and the position on the rack are provided. The system includes a rack comprising a plurality of positions at which pieces of equipment can be mounted on the rack, and a plurality of radiofrequency identification (RFID) tags attached to the rack, each of the plurality of RFID tags being attached to the rack at one of the plurality of positions on the rack and being operable to transmit information regarding the rack and the position on the rack at which the RFID tag is attached.

### FIELD OF THE INVENTION

The present invention relates generally to associating rack mounted equipment with rack position.

### BACKGROUND OF THE INVENTION

Equipment, such as servers, network devices, audio/video decks, telecommunications gear, or the like, may be mounted on racks. In certain environments, such as data centers, where there are numerous pieces of equipment mounted on various racks, it is sometimes difficult to determine on which rack a particular piece of equipment is mounted and at which position on the rack the particular piece of equipment is mounted.

### SUMMARY OF THE INVENTION

System, method, and computer program for associating a piece of equipment mounted at a position on a rack with the rack and the position on the rack are provided. The system includes a rack comprising a plurality of positions at which pieces of equipment can be mounted on the rack, and a plurality of radiofrequency identification (RFID) tags attached to the rack, each of the plurality of RFID tags being attached to the rack at one of the plurality of positions on the rack and being operable to transmit information regarding the rack and the position on the rack at which the RFID tag is attached. One of the plurality of RFID tags attached to the rack is associated with an RFID tag not attached to the rack.

### BRIEF DESCRIPTION OF THE DRAWINGS

FIG. 1 depicts a system according to an implementation of the invention.

FIGS. 2-3 illustrate portable RFID tag readers according to various implementations of the invention.

FIG. 4 shows a process for associating a piece of equipment mounted at a position on a rack with the rack and the position on the rack according to an implementation of the invention.

FIG. 5 is a block diagram of a data processing system with which implementations of the invention can be implemented.

### DETAILED DESCRIPTION

The present invention generally relates to associating rack mounted equipment with rack position. The following description is presented to enable one of ordinary skill in the art to make and use the invention and is provided in the context of a patent application and its requirements. The present invention is not intended to be limited to the implementations shown, but is to be accorded the widest scope consistent with the principles and features described herein.

Racks may be used to mount various types of equipment. For example, servers, network devices, audio/video decks, telecommunications gear, or the like may be rack mounted. Each rack usually has a predefined number of positions at which a piece of equipment can be mounted. The amount of usable vertical space at each position in a rack has been standardized to 1.75 inches, which is frequently referred to as one rack unit or one U. Racks are sometimes defined in terms of U, such as a 20 U rack.

U is also used as a standard unit of measure to define the size of rack-mountable equipment. For example, the size of a piece of equipment may be 4U, which means the piece of equipment will occupy four positions in a rack. Thus, a 20 U rack that only has 5 pieces of equipment mounted thereon may not have any position available to mount an additional piece of equipment.

Equipment mounted on racks may be half-rack units that only occupy half of the width of a rack. For example, a 2 U half-rack piece of equipment will occupy 2 positions in a rack, but only half of the width of a rack. Hence, in theory, two pieces of equipment that are both 2 U half-rack in size may occupy the same 2 positions in a rack, one on each side of the rack.

When an environment includes numerous pieces of equipment mounted on various racks, such as in data centers, it may be difficult to determine where a particular piece of equipment is located (e.g., which rack and at which position on the rack). Being able to determine what equipment is mounted on each rack and at what position in the rack will allow better equipment and rack management.

For example, if a new piece of equipment needs to be mounted in a rack environment and the new piece of equipment is of size 4 U, then knowing what equipment is mounted on each rack and at what position will make it easier to determine which rack has space for the new piece of equipment to be mounted. Knowing what equipment is mounted on each rack and at what position may also make it easier to manage problems relating to power, acoustics, thermal properties, or the like.

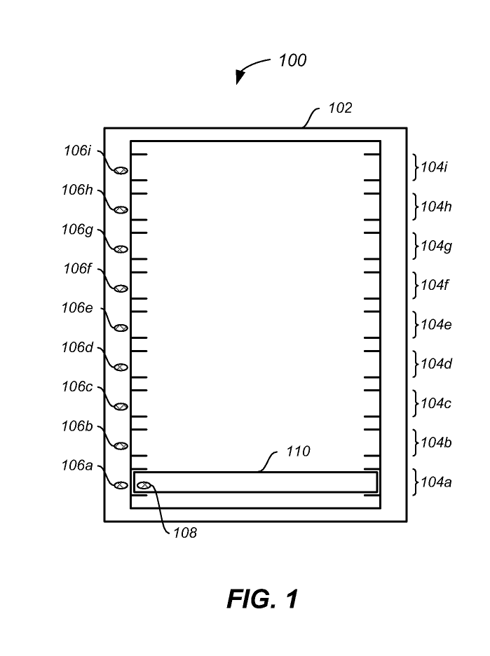

Depicted in FIG. 1 is a system 100 according to an implementation of the invention. System 100 includes a rack 102. Rack 102 includes a plurality of positions 104 at which pieces of equipment can be mounted on rack 102. A plurality of radiofrequency identification (RFID) tags 106 is attached to rack 102.

Attachment of each of the plurality of RFID tags 106 may occur during manufacturing of rack 102 or anytime thereafter. One or more RFID tags 106 may be attached to rack 102 at a different period of time than one or more other RFID tags 106 (e.g., RFID tags 106 may be attached to rack 102 on a need basis). In the implementation, each RFID tag 106 is attached to the rack at one of the plurality of positions 104 of rack 102.

An RFID tag is an object that can be incorporated or added to a product, animal, or person to store information regarding the product, animal, or person, and transmit that information via radio waves. There are different types of RFID tags, such as, passive, active, and semi-passive. Passive RFID tags usually do not have an internal power source and only transmit information in response to a request signal, such as a signal sent through an RFID tag reading device. Active RFID tags have an internal power source and the ability to broadcast information without being requested to do so. Semi-passive RFID tags have an internal power source, but only transmit information in response to a request.

Each RFID tag 106 is operable to transmit information regarding rack 102 and the position in rack 102 at which the RFID tag 106 is attached. For example, RFID tag 106b will be able to transmit information regarding rack 102 and position 104b at which RFID tag 106b is attached. The information transmitted by RFID tag 106b may be, for example, an identifier for rack 102 (e.g., serial number) and an identifier for position 104b (e.g., position 2). Positions 104 in rack 102 may be identified in order from top down or from bottom up.

In FIG. 1, RFID tag 106a attached to rack 102 at position 104a is associated with an RFID tag 108 not attached to rack 102. RFID tag 108 is attached to a piece of equipment 110 that is mounted on rack 102 at position 104a. RFID tag 108 is operable to transmit information regarding equipment 110. The information transmitted by RFID tag 108 may include, for example, an identifier for equipment 110 (e.g., serial number) and a size of equipment 110 (e.g., 1 U). RFID tag 106a and RFID tag 108 are positioned such that the two tags can be read together in order to associate equipment 110 with rack 102 and position 104a.

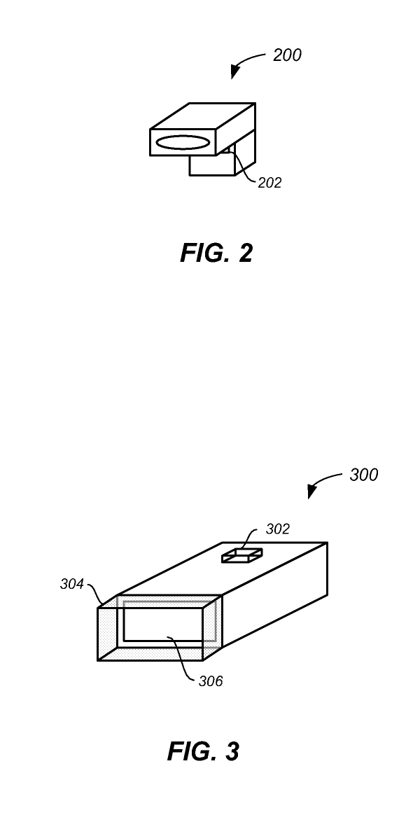

RFID tags 106a and 108 may be read using a portable RFID tag reader (not shown). For instance, a portable RFID tag reader can be positioned over both RFID tags 106a and 108 and then activated to read RFID tag 106a together with RFID tag 108. Illustrated in FIG. 2-3 are portable RFID tag readers 200 and 300 according to various implementations of the invention.

Portable RFID tag reader 200 is a handgun type reader that is activated by pulling a trigger 202 on portable RFID tag reader 200. Portable RFID tag reader 300 is a remote type reader that is activated by pushing a button 302. Portable RFID reader 300 includes a shield 304 around signal transmission/receiving area 306 to help assure that only tags within area 306 covered by shield 304 will be read. Shield 304 may be made of metal. A shield (not shown) can also be added to portable RFID tag reader 200.

In one implementation, an indicator (not shown), such as an LED (light-emitting diode), is added to portable RFID tag reader 200 or 300 to indicate whether RFID tags have been read properly. For example, a green LED can light up when RFID tags have been read properly or a red LED can light up when RFID tags have not been correctly read.

After RFID tags 106a and 108 are read together and associated with one another, which in turn, associates equipment 110 with rack 102 and position 104a, data relating to the association may be transmitted to a computer system (not shown) managing rack 102 and equipment 110 in system 100. Data may be transmitted by directly connecting the portable RFID reader to the computer system and downloading the data to the computer system (e.g., via a docking station).

Data may also be transmitted to the computer system through wireless technology, such as Bluetooth, WiFi, or the like. Transmission of the association data may be immediate, may occur periodically, may be at a particular point in time (e.g., after all tag associations in system 100 have been read), may be in response to a request, or the like.

The plurality of RFID tags 106 and RFID tag 108 may be passive, active, semi-passive, or some combination thereof. In addition, an RFID tag 106 may not be attached to rack 102 at each position 104 in another implementation. Multiple RFID tags 106 may also be attached to rack 102 at a single position 104 (e.g., one on each side of rack 102).

Although not depicted in FIG. 1, one or more other pieces of equipment may be mounted on rack 102. And, as discussed above, each piece of equipment need not expand the whole width of rack 102 and may occupy more than one position 104 in rack 102.

When a piece of equipment occupies more than one position of a rack, an RFID tag attached to the piece of equipment can be associated with just one RFID tag attached to the rack (e.g., an RFID tag attached to the rack at a position in which one end of the piece of equipment is attached). Then the number of positions occupied by the piece of equipment can be determined based on a size of the piece of equipment.

The RFID tag attached to the piece of equipment can also be associated with the RFID tag attached to the rack at each of the positions occupied by the piece of equipment. More than one RFID tag may also be attached to a piece of equipment. For example, a 3 U piece of equipment mounted on a rack may have 3 RFID tags attached thereto, each of which is situated in close proximity to and can be read together with one of 3 RFID tags attached to the rack at the 3 positions of the rack occupied by the 3 U piece of equipment.

System 100 may also include additional racks with equipment mounted thereon (not shown). Further, racks may be various sizes, shapes, and designs (e.g., taller, shorter, wider, narrower, more positions, less positions, more holes, less holes, completely enclosed with one or more doors, completely open with only poles in which to mount equipment, wall mounted, freestanding, etc.).

By strategically placing RFID tags on pieces of equipment and on racks at specific positions, it is much easier to associate a piece of equipment with a particular rack and a particular position in the rack the piece of equipment is mounted on. In addition, costs associated with implementing RFID tags should be relatively low because passive RFID tags are inexpensive and only a portable RFID tag reader will be needed to associate equipment with racks and positions. Constant updates are also not necessary as the association data may only need to be updated, for example, once a month, once a quarter, or the like.

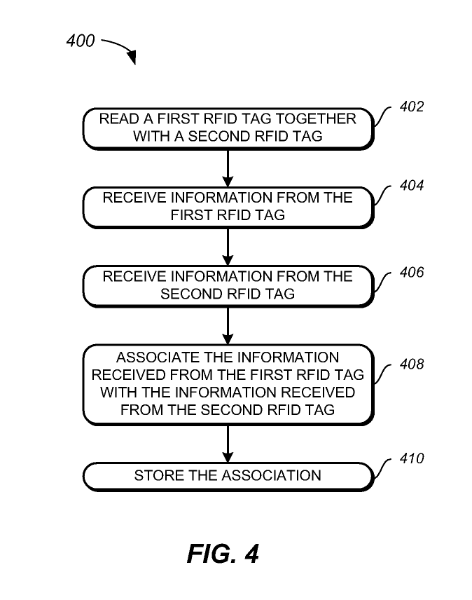

Shown in FIG. 4 is a process 400 for associating a piece of equipment mounted at a position on a rack with the rack and the position on the rack according to an implementation of the invention. At 402, a first radiofrequency identification (RFID) tag is read together with a second radiofrequency identification (RFID) tag. The first RFID tag is attached to the rack at the position on the rack at which the piece of equipment is mounted. The second RFID tag is attached to the piece of equipment mounted at the position on the rack.

In the implementation, the first RFID tag and the second RFID tag are positioned such that the first RFID tag and the second RFID tag can be read together. The first RFID tag and the second RFID tag are passive RFID tags in one implementation. The first RFID tag and the second RFID tag may be read together using a portable RFID tag reader.

At 404, information is received from the first RFID tag regarding the rack and the position on the rack at which the piece of equipment is mounted. In one implementation, the information received from the first RFID tag includes an identifier for the rack and an identifier for the position on the rack at which the piece of equipment is mounted.

At 406, information is received from the second RFID tag regarding the piece of equipment. In one implementation, the information received from the second RFID tag includes an identifier for and a size of the piece of equipment mounted on the rack. At 408, the information received from the first RFID tag is associated with the information received from the second RFID tag.

At 410, the association is stored. In one implementation, the association is stored by transmitting the association to a computer system and saving the association to a storage device of the computer system. Transmission of the association may be wired or wireless.

The invention can take the form of an entirely hardware implementation, an entirely software implementation, or an implementation containing both hardware and software elements. In one aspect, the invention is implemented in software, which includes, but is not limited to, application software, firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include DVD, compact disk—read-only memory (CD-ROM), and compact disk—read/write (CD-R/W).

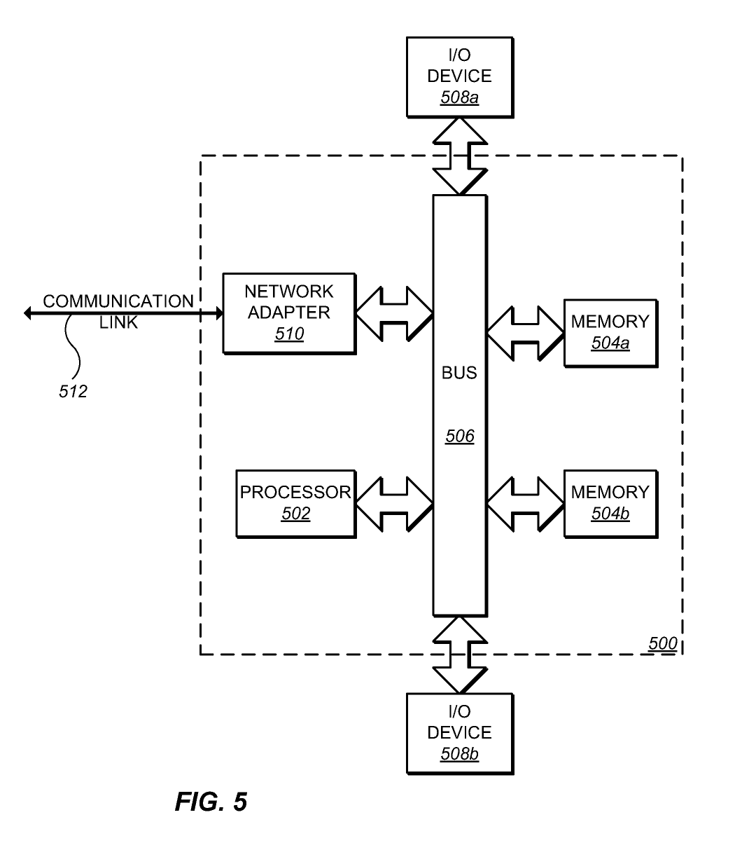

FIG. 5 depicts a data processing system 500 suitable for storing and/or executing program code. Data processing system 500 includes a processor 502 coupled to memory elements 504a-b through a system bus 506. In other implementations, data processing system 500 may include more than one processor and each processor may be coupled directly or indirectly to one or more memory elements through a system bus.

Memory elements 504a-b can include local memory employed during actual execution of the program code, bulk storage, and cache memories that provide temporary storage of at least some program code in order to reduce the number of times the code must be retrieved from bulk storage during execution. As shown, input/output or I/O devices 508a-b (including, but not limited to, keyboards, displays, pointing devices, etc.) are coupled to data processing system 500. I/O devices 508a-b may be coupled to data processing system 500 directly or indirectly through intervening I/O controllers (not shown).

In the implementation, a network adapter 510 is coupled to data processing system 500 to enable data processing system 500 to become coupled to other data processing systems or remote printers or storage devices through communication link 512. Communication link 512 can be a private or public network. Modems, cable modems, and Ethernet cards are just a few of the currently available types of network adapters.

While various implementations for associating a piece of equipment mounted at a position on a rack with the rack and the position on the rack have been described, the technical scope of the present invention is not limited thereto. For example, the present invention is described in terms of particular systems having certain components and particular methods having certain steps in a certain order. One of ordinary skill in the art, however, will readily recognize that the methods described herein can, for instance, include additional steps and/or be in a different order, and that the systems described herein can, for instance, include additional or substitute components. Hence, various modifications or improvements can be added to the above implementations and those modifications or improvements fall within the technical scope of the present invention.

1. A system comprising:
a rack, the rack comprising a plurality of positions at which pieces of equipment can be mounted on the rack; and
a plurality of radiofrequency identification (RFID) tags attached to the rack, wherein
each of the plurality of RFID tags attached to the rack is
attached to the rack at one of the plurality of positions on the rack, and
operable to transmit information regarding the rack and the position on
the rack at which the RFID tag is attached, and
one of the plurality of RFID tags attached to the rack is associated with an RFID tag not attached to the rack.

2. The system of claim 1, wherein the RFID tag not attached to the rack and associated with the one RFID tag attached to the rack is
attached to a piece of equipment mounted at the position on the rack at which the one RFID tag is attached to the rack, and
operable to transmit information regarding the piece of equipment.

3. The system of claim 2, wherein the information regarding the piece of equipment comprises an identifier for the piece of equipment and a size of the piece of equipment.

4. The system of claim 1, wherein the information regarding the rack and the position on the rack comprises an identifier for the rack and an identifier for the position on the rack at which the RFID tag is attached.

5. The system of claim 1, wherein the plurality of RFID tags attached to the rack and the RFID tag not attached to the rack are passive RFID tags.

6. The system of claim 1, further comprising:
a portable RFID tag reader operable to receive information transmitted by any RFID tag.

7. The system of claim 6, wherein the portable RFID tag reader comprises a shield to ensure that no more than two RFID tags can be read together.

8. A method for associating a piece of equipment mounted at a position on a rack with the rack and the position on the rack, the method comprising:
reading a first radiofrequency identification (RFID) tag together with a second radiofrequency identification (RFID) tag, the first RFID tag being attached to the rack at the position on the rack at which the piece of equipment is mounted and the second RFID tag being attached to the piece of equipment mounted at the position on the rack, the first RFID tag and the second RFID tag being positioned such that the first RFID tag and the second RFID tag can be read together;
receiving information from the first RFID tag regarding the rack and the position on the rack at which the piece of equipment is mounted;
receiving information from the second RFID tag regarding the piece of equipment;
associating the information received from the first RFID tag with the information received from the second RFID tag; and
storing the association.

9. The method of claim 8, wherein the first RFID tag and the second RFID tag are passive RFID tags.

10. The method of claim 8, wherein receiving information from the first RFID tag comprises:
receiving an identifier for the rack and an identifier for the position on the rack at which the piece of equipment is mounted.

11. The method of claim 8, wherein receiving information from the second RFID tag comprises:
receiving an identifier for the piece of equipment and a height of the piece of equipment.

12. The method of claim 8, wherein reading the first RFID tag together with the second RFID tag comprises:
reading the first RFID tag together with the second RFID tag using a portable RFID tag reader.

13. The method of claim 12, wherein the portable RFID tag reader comprises a shield to ensure that no more than two RFID tags can be read together.

14. The method of claim 8, wherein storing the association comprises:
transmitting the association to a computer system; and
saving the association to a storage device of the computer system.

15. The method of claim 14, wherein transmitting the association comprises:
transmitting the association to the computer system via a wireless connection to the computer system.

16. A computer program product including a computer-readable medium encoded with a computer program for associating a piece of equipment mounted at a position on a rack with the rack and the position on the rack, the computer program comprising executable instruction for:
reading a first radiofrequency identification (RFID) tag together with a second radiofrequency identification (RFID) tag, the first RFID tag being attached to the rack at the position on the rack at which the piece of equipment is mounted and the second RFID tag being attached to the piece of equipment mounted at the position on the rack, the first RFID tag and the second RFID tag being positioned such that the first RFID tag and the second RFID tag can be read together;
receiving information from the first RFID tag regarding the rack and the position on the rack at which the piece of equipment is mounted;
receiving information from the second RFID tag regarding the piece of equipment;
associating the information received from the first RFID tag with the information received from the second RFID tag; and
storing the association.

17. The computer program product of claim 16, wherein
receiving information from the first RFID tag comprises receiving an identifier for the rack and an identifier for the position on the rack at which the piece of equipment is mounted; and
receiving information from the second RFID tag comprises receiving an identifier for the piece of equipment and a height of the piece of equipment.

18. The computer program product of claim 16, wherein reading the first RFID tag together with the second RFID tag comprises:
reading the first RFID tag together with the second RFID tag using a portable RFID tag reader.

19. The computer program product of claim 16, wherein storing the association comprises:
transmitting the association to a computer system; and
saving the association to a storage device of the computer system.

20. The computer program product of claim 19, wherein transmitting the association comprises:
transmitting the association to the computer system via a wireless connection to the computer system.
